(19) United States
(12) Patent Application Publication
(10) Pub. No.: US 2009/0248427 A1
(43) Pub. Date: Oct. 1, 2009

(54) INITIATIVE DESIGNER

(76) Inventor: Jerome Dale JOHNSON, Bayfield, WI (US)

Correspondence Address: Hershkovitz & Associates, LLC, 2845 Duke Street, Alexandria, VA, 22314, US

(21) Appl. No.: 12/055,301

(22) Filed: Mar. 25, 2008

(51) Int. Cl. G06Q 10/00; G06Q 30/00; G06F 17/30

(52) U.S. Cl. 705/1; 707/104.1; 707/E17.009

(57) ABSTRACT

A method, system and a computer program product for an interactive smart game plan for one or more growth initiatives having an initiative designer for designing, creating, launching and tracking growth initiatives are provided. The initiative designer of the method, system and computer program can have an electronic component configured to interact with one or more users by accepting and displaying growth initiative information specified by the user and obtained from multiple data sources, pertaining to the growth initiative, wherein the growth initiative information has at least one of, basic growth initiative information, a target segment, a target participant, an incentive, a business rule, a marketing tool, sales execution instructions, detailed prospect information, prospect background information, and a recommended game plan to a user to execute the growth initiative.

### CROSS-REFERENCE TO RELATED APPLICATIONS

This disclosure is related to the disclosure of U.S. patent application titled “Interactive Smart Game Plan,” filed concurrently herewith, having Attorney Docket No. P68369, the disclosure of which is expressly incorporated by reference herein in its entirety.

### BACKGROUND OF THE DISCLOSURE

1. Field of the Disclosure

This disclosure relates to systems, methods and computer program products for creating, launching and tracking growth initiatives. The systems, methods and computer program products according to the present disclosure can operate with an interactive smart game plan that can utilize an interactive smart electronic mail and/or a personalized sales execution electronic mail as disclosed in U.S. patent application titled “Interactive Smart Game Plan,” filed concurrently herewith, having Attorney Docket No. P68369.

2. Discussion of Background Information

Previous to this disclosure, there were some applications that only indirectly assisted with growth initiatives or offered limited functionalities. There were no systems that directly connected the growth initiative to the sales and the execution of the growth initiative by a salesperson and are considered comprehensive or able to integrate information in an efficient manner.

For example, traditionally, resources such as presentations, case studies, training material as well as tools were placed into a channel sales portal, i.e., a generic web portal that is not specific to a growth initiative. The salespersons needed to determine what they needed, when they needed it, and then find the resources and tools, combine them and use them in a sales situation. It was therefore, up to the salesperson to search the copious amount of information provided in these web portals and determine which information was relevant to the growth initiative and which tools were needed to execute the growth initiative. Most salespersons find this method very frustrating and ultimately do not use the information or tools. When combined with a multitude of concurrent sales promotions, product announcements and other growth initiatives, effective execution by channel partners is sometimes impossible or at least very difficult. There may be no guidance on how the information is combined, and how everything is ultimately executed is based on trial and error via the human experience. There is no system that is user-friendly yet integrated and can proactively communicate with a specific salesperson, a specific prospect, prospect background information, and/or suggested sales execution steps while being capable of training the salesperson for implementing the growth initiative.

### SUMMARY OF THE DISCLOSURE

The present disclosure provides for systems, methods and computer program products for creating, launching and tracking growth initiatives. The systems, methods and computer program products according to the present disclosure can operate with an interactive game plan that can utilize an interactive smart electronic mail and/or a personalized sales execution electronic mail as disclosed in the above-mentioned U.S. patent application titled “Interactive Smart Game Plan.”

In one or more embodiments, the systems, methods and computer program products according to the present disclosure include an initiative designer that can provide the ability to specify at least one of, a target market, target participants, applicable incentives, business rules, content, tools, and recommended game plan (activities) to a salesperson to execute the growth initiative. The initiative designer can use a federation of data sources, both external databases and local user databases, to design a more effective growth initiative.

According to one aspect of the present disclosure, the initiative designer can provide the ability for the growth initiative creator (a user who creates or designs the growth initiative by using the initiative designer) to define the details of the growth initiative to be launched. The initiative designer can provide the ability for the growth initiative creator to look at growth initiatives that were previously defined and utilize the information learned to help improve the definition and execution of the new growth initiative. The growth initiative creator can utilize the initiative designer in a specific sequence as outlined below (although this sequence is not mandatory).

The growth initiative creator can first enter basic information about the growth initiative (such as, but is not limited to, Reference ID, Name, Sales Goal, Budget, Description, Type, and Effective Dates).

Once the basic information of the growth initiative has been entered, the growth initiative creator can define the target market (i.e. segment of population to which the growth initiative is designed to be sold). One of the unique approaches the initiative designer provides as part of this step is the ability to use multiple data sources (internal data sources and external data sources) to define the target market. The multiple data sources are logically federated together to appear as a single database to the user (even though the data sources may be from many physical sources). The initiative designer can have tools that help the growth initiative creator analyze the rules that were created during the target market definition which show the growth initiative creator how many prospects are identified as a result of the rules definition. The growth initiative creator then has the ability to segment the target market into “Good,” “Better,” or “Best” prospects.

In one or more embodiments, the initiative designer can then guide the growth initiative creator to define who within the organization should receive this growth initiative. Only the salespeople specific to an organizational group or an organizational region (for example, only salespeople within the western region) will receive information about the defined growth initiative.

In one or more embodiments, the initiative designer can then guide the growth initiative creator to define the incentives that are being offered as part of the growth initiative. The incentives can be targeted to the customer qualifying for the growth initiative, and/or the salesperson responsible for selling the qualifying products and/or services and/or any other group or users as required.

In one or more embodiments, the initiative designer can then guide the growth initiative creator to define the products and/or services that will be offered as part of the growth initiative.

In one or more embodiments, the initiative designer can then guide the growth initiative creator to define the interactive game plan to be executed by an individual or a sales team. The interactive game plan can include the activities to be executed during the sales process as well as the content and tools recommended to be used during the execution of the growth initiative. The game plan can be communicated via e-mail and/or calendar events to the sales team.

In one or more embodiments, the initiative designer can then guide the growth initiative creator to define the metrics/measurements that are desired to be tracked during the execution of the growth initiative.

In one or more embodiments, when the growth initiative creator has finally completed all necessary steps for creating the growth initiative, the growth initiative creator can publish the growth initiative. The process of publishing the growth initiative basically starts the activities that were defined in the game plan.

One of the advantages of the initiative designer of the present disclosure is the ability to look at the results of past growth initiatives to see how well those growth initiatives accomplished the desired goals. Typically, companies can launch certain growth initiatives, but do not have the ability to go back and see if the desired activity/sales goals were obtained.

Another advantage of the initiative designer of the present disclosure is the ability to create interactive smart game plans. The initiative designer can be viewed as an “input” of information for the growth initiative while the interactive smart game plan is an “output” of this information and growth initiative such that execution of steps for a game plan is possible. Other systems can assist with certain growth initiatives, but do not or cannot connect the growth initiative to sales and execution of the growth initiative by the salesperson. The systems, methods and computer program products according to the present disclosure can do this. The systems, methods and computer program products have the ability to convert a growth initiative, which is targeted to a specific set of prospects, to a Game Plan (Activities) for each salesperson associated with the growth initiative to maximize revenue for a growth initiative. Once the growth initiative has been designed, published and the salesperson accepts the growth initiative, the Game Plan's activities can be integrated into the personal calendar of the salesperson via electronic mail distribution. This integration into the salesperson's personal calendar aids the execution and effectiveness of the growth initiative.

Another advantage of the initiative designer according to the present disclosure is the ability to create growth initiatives from multiple physical data sources. The initiative designer can present the multiple data sources to the growth initiative creator in a single “logical” view of the data. This federation of the data can provide the growth initiative creator the ability to use multiple data sources when defining the target market for the growth initiative. Other systems require a user to collate the multiple data sources manually, or to create a separate new, single data source, which is actually a merger of the multiple data sources.

Therefore, the initiative designer present within the systems, methods and computer program products according to the present disclosure can help execute the interactive smart game plan that exists within the systems, methods and computer programs disclosed in the above-mentioned U.S. patent application titled “Interactive Smart Game Plan.” Thus, these systems, methods and computer program products can utilize electronic mail to proactively communicate to a user a specific prospect, prospect background information, suggested sales execution steps, and/or training information and/or steps so that the salesperson can implement a growth initiative. The systems, methods and computer program products can utilize electronic mail to allow the salesperson to input specific sales execution steps into his or her calendar. However, the specific sales execution steps that are defined by the initiative designer can be automatically transferred to the salesperson's electronic calendar. The systems, methods and computer program product of the present disclosure are robust such that they can be generalized for more than one salesperson but can be specific and personalized for an individual salesperson based on his or her needs and potential.

As a result, the systems, methods and computer program products can allow a growth initiative creator to quickly create a growth initiative and then have the growth initiative executed by a salesperson.

The interactive smart electronic mail that is utilized is dynamically generated and personalized. The interactive smart game plan can be time specific, information specific, tool specific and has monetary value to not only the salesperson but also to a growing company.

Therefore, according to one aspect of the present disclosure, a system is provided, having an initiative designer for creating, launching or tracking one or more growth initiatives, the initiative designer including an electronic component configured to interact with one or more growth initiative creators by accepting and displaying growth initiative information specified by the growth initiative creator and obtained from multiple data sources, pertaining to the growth initiative, wherein the growth initiative information includes at least one of, basic growth initiative information, a target segment, a target participant, an incentive, a business rule, a marketing tool, sales execution instructions, detailed prospect information, prospect background information and a recommended game plan to a user to execute the growth initiative.

The multiple data sources can include at least one of, one or more external databases and one or more local user databases. These databases are preferably, relational databases.

The multiple data sources are preferably logically federated together to appear as a single database to the growth initiative creator without the need of the growth initiative creator to collate information from the multiple data sources.

In one or more embodiments, the initiative designer is configured to display one or more previously defined growth initiatives to the growth initiative creator to improve the definition and execution of a new growth initiative.

In one or more embodiments, the initiative designer further includes tools configured to assist the growth initiative creator in analyzing rules that were created during a target market definition which show the growth initiative creator how many prospects are identified.

The basic growth initiative information can include at least one of, a reference identification, a growth initiative name, a sales goal, a growth initiative budget, a growth initiative description, a growth initiative type and effective dates for the growth initiative.

In one or more embodiments, the initiative designer is configured to, at least one of:

guide the growth initiative creator to define who within an organization should receive the growth initiative information;

guide the growth initiative creator to define the incentives that are being offered as part of the growth initiative;

guide the growth initiative creator to define products and/or services that will be offered as part of the growth initiative;

guide the user to define an interactive game plan to be executed by an individual or a sales team;

guide the growth initiative creator to define the metrics or measurements that are desired to be tracked during the execution of the growth initiative; and

allow the growth initiative creator to publish the growth initiative for others to view.

In one or more embodiments, the initiative designer is configured to allow the growth initiative creator to view results of past growth initiatives in order to see how well the past growth initiatives accomplished a desired goal.

In one or more embodiments, the initiative designer is configured to receive information from the growth initiative creator to display at least one of, tools, resources and activities for execution at an appropriate time.

In one or more embodiments, at least one of, tools, resources and activities for execution are selected by the growth initiative creator and is/are displayed at an orderly time to guide a salesperson to maximize results for a game plan.

In one or more embodiments, the initiative designer has at least one of, a product selection functionality, a segmentation functionality, an incentive functionality, a game plan functionality and an analytics functionality. In one or more embodiments, the initiative designer is configured to operate at least one of, as a stand-alone computer product/on a computer-readable medium, on a world-wide web, on a wide area network, and on a local area network.

According to another aspect of the present disclosure, there is provided a method for designing one or more growth initiatives for a smart game plan by one or more salespersons, wherein the method includes utilizing and interacting with an electronic component that accepts and displays growth initiative information specified by the growth initiative creator and obtained from multiple data sources, pertaining to the growth initiative, wherein the growth initiative information includes at least one of, basic growth initiative information, a target segment, a target participant, an incentive, a business rule, a marketing tool, sales execution instructions, detailed prospect information prospect background information and a recommended game plan to a user to execute the growth initiative.

In one or more embodiments, the growth initiative creator utilizes multiple data sources including at least one of, one or more external databases and one or more local user databases. Preferably, the databases are relational databases.

In one or more embodiments, the growth initiative creator utilizes multiple data sources that are logically federated together to appear as a single database to the growth initiative creator without the need of the growth initiative creator to collate information from the multiple data sources.

In one or more embodiments, the growth initiative creator utilizes the initiative designer to display one or more previously defined growth initiatives to improve the definition and execution of a new growth initiative.

In one or more embodiments, the growth initiative creator utilizes tools from the initiative designer to assist the growth initiative creator in analyzing rules that were created during a target market definition which show the growth initiative creator how many prospects are identified.

In one or more embodiments, the basic growth initiative information includes at least one of, a reference identification, a growth initiative name, a sales goal, a growth initiative budget, a growth initiative description, a growth initiative type and effective dates for the growth initiative.

In one or more embodiments, the growth initiative creator utilizes the initiative designer to, at least one of:

guide the growth initiative creator to define who within an organization should receive the growth initiative information;

guide the growth initiative creator to define the incentives that are being offered as part of the growth initiative;

guide the growth initiative creator to define products and/or services that will be offered as part of the growth initiative;

guide the user to define an interactive game plan to be executed by an individual or a sales team;

guide the growth initiative creator to define the metrics or measurements that are desired to be tracked during the execution of the growth initiative; and

allow the growth initiative creator to publish the growth initiative for others to view.

In one or more embodiments, the growth initiative creator utilizes the initiative designer to allow the growth initiative creator to view results of past growth initiatives in order to see how well the past growth initiatives accomplished a desired goal.

In one or more embodiments, the growth initiative creator utilizes the initiative designer to display at least one of, tools, resources and activities for execution at an appropriate time.

In one or more embodiments, at least one of, tools, resources and activities for execution are selected by the growth initiative creator and is/are displayed at an orderly time to guide a salesperson to maximize results for a game plan.

In one or more embodiments, the initiative designer has at least one of, a product selection functionality, a segmentation functionality, an incentive functionality, a game plan functionality and an analytics functionality.

In one or more embodiments, the initiative designer is configured to operate at least one of, as a stand-alone computer product/on a computer-readable medium, on a world-wide web, on a wide area network, and on a local area network.

According to another aspect of the present disclosure, a computer program product readable by a computer system is provided, having computer-executable instructions that when executed cause a processor of the computer system to perform a method for generating one or more display screens for one or more growth initiative creators to input information for one or more growth initiatives, the method including utilizing and interacting with an electronic component that accepts and displays growth initiative information specified by the growth initiative creator and obtained from multiple data sources, pertaining to the growth initiative, wherein the growth initiative information includes at least one of basic growth initiative information, a target segment, a target participant, an incentive, a business rule, a marketing tool, sales execution instructions, detailed prospect information prospect background information and a recommended game plan to a user to execute the growth initiative.

In one or more embodiments, the computer program readable product allows the growth initiative creator to utilize multiple data sources having at least one of, one or more external databases and one or more local user databases. Preferably, the databases are relational databases.

In one or more embodiments, the computer program readable product allows the growth initiative creator to utilize multiple data sources that are logically federated together to appear as a single database to the growth initiative creator without the need of the growth initiative creator to collate information from the multiple data sources.

In one or more embodiments, the computer program readable product allows the growth initiative creator to utilize the initiative designer to display one or more previously defined growth initiatives to improve the definition and execution of a new growth initiative.

In one or more embodiments, the computer program readable product allows the growth initiative creator to utilize tools from the initiative designer to assist the growth initiative creator in analyzing rules that were created during a target market definition which show the growth initiative creator how many prospects are identified.

In one or more embodiments, the basic growth initiative information as mentioned above includes at least one of, a reference identification, a growth initiative name, a sales goal, a growth initiative budget, a growth initiative description, a growth initiative type and effective dates for the growth initiative.

In one or more embodiments, the computer program readable product allows the growth initiative creator to utilize the initiative designer to, at least one of:

guide the growth initiative creator to define who within an organization should receive the growth initiative information;

guide the growth initiative creator to define the incentives that are being offered as part of the growth initiative;

guide the growth initiative creator to define products and/or services that will be offered as part of the growth initiative;

guide the user to define an interactive game plan to be executed by an individual or a sales team;

guide the growth initiative creator to define the metrics or measurements that are desired to be tracked during the execution of the growth initiative; and

allow the growth initiative creator to publish the growth initiative for others to view.

In one or more embodiments, the computer program readable product allows the growth initiative creator to utilize the initiative designer to allow the growth initiative creator to view results of past growth initiatives in order to see how well the past growth initiatives accomplished a desired goal.

In one or more embodiments, the computer program readable product allows the growth initiative creator to utilize the initiative designer to display at least one of tools, resources and activities for execution at an appropriate time.

In one or more embodiments, at least one of, tools, resources and activities for execution are selected by the growth initiative creator and is/are displayed at an orderly time to guide a salesperson to maximize results for a game plan.

In one or more embodiments, the computer program readable product allows at least one of, a product selection functionality, a segmentation functionality, an incentive functionality, a game plan functionality and an analytics functionality.

In one or more embodiments, the computer program readable product is configured to operate at least one of, as a stand-alone computer product/on a computer-readable medium, on a world-wide web, on a wide area network, and on a local area network.

Other exemplary embodiments and advantages of the present invention may be ascertained by reviewing the present disclosure and the accompanying drawing.

### BRIEF DESCRIPTION OF THE DRAWINGS

This disclosure is further described in the detailed description which follows, in reference to the noted plurality of drawings by way of non-limiting examples of embodiments of the present disclosure, in which like reference numerals represent similar parts throughout the several views of the drawings, and wherein:

FIG. 1 shows a display screen of a starting page for an exemplary designer;

FIG. 2 shows a display screen for “Create New Initiative” according to one aspect of the initiative designer;

FIG. 3 shows a display screen for defining segments or target markets of the growth initiative for the initiative designer;

FIG. 4 shows a display screen that the growth initiative creator is taken to when the growth initiative creator hits the “Save/Add New” button shown in FIG. 3;

FIG. 5 shows a display screen that the growth initiative creator is taken to when the growth initiative creator hits the “Best Practice” button at the top of the screen of FIG. 3;

FIG. 6 shows a display screen upon selecting the “Analyze” button from FIG. 3;

FIG. 7 shows the “Define Participants” display screen when this sub-menu is selected;

FIG. 8 shows a display screen where the growth initiative creator can define the products for the growth initiative;

FIG. 9 shows a display screen where the growth initiative creator can define incentives for the growth initiative and/or game plan;

FIG. 10 shows a display screen where the growth initiative creator can define a game plan for the growth initiative;

FIG. 11 shows a display screen when the growth initiative creator selects the “Add Event” button;

FIG. 12 shows a display screen where the growth initiative creator can define measurements when creating a new growth initiative; and

FIG. 13 shows the Data Federation of databases that can be utilized for the initiative designer.

### DETAILED DESCRIPTION OF THIS DISCLOSURE

The term “salesperson(s)” is used interchangeably with the term “user(s)” herein. The user and salesperson can include any user, i.e., someone who is not an active salesperson but directs a salesperson, or any business person that may or may not be actively involved in sales but is directly or indirectly involved in the daily or intermittent operation of a company. Thus, the salesperson or user can be anyone who can use the initiative designer, method or system according to the present disclosure and can benefit from such, and the term “salesperson” is used in an exemplary purpose and not intended to be limited to any particular user. The term “user(s)” and “growth initiative creator(s)” are used interchangeably when it is described how an initiative designer is being utilized to create a growth initiative that can ultimately be implemented in a game plan. In this context, these terms are meant for anyone who defines or assists in defining details of the growth initiative to be launched, or sets up execution steps, rules and requirements for the growth initiative and/or game plan.

The term “interactive smart game plan,” “smart game plan,” “game plan,” and “plan” are used interchangeably herein. These terms can be used to describe the inventive systems, methods and computer program products that use the initiative designer according to the present disclosure, or are what result from using the initiative designer. They can include activities or events associated with a growth initiative. These activities can be system-generated activities that the salesperson needs to complete as part of the initiative growth.

The term “prospect(s)” is defined herein as a collection or a group of accounts or contacts (individual salespersons) for which a growth initiative is targeted. The prospect list can be derived from company owned customer/contact list, or the prospect list can be derived from the salesperson/contact list or elsewhere. Because of this, the salesperson can be independent of the company.

The term “growth initiative(s)” is defined herein as programs, events, and/or initiatives that help companies at least one of, create demand, add value throughout the sales channel, increase market share and drive revenue. The term “growth initiative(s)” is used interchangeably with the terms “initiatives,” “marketing initiatives,” “sales initiatives,” “marketing programs,” and “sales program.” The term “growth initiative(s)” can mean to include one or more of these initiatives or programs as understood in the industry. Thus, the term “growth initiative(s)” can include a sales initiative(s) which is a broad description defining proactive sales programs launched by the corporation to their sales channels. When effectively launched and executed, sales initiatives offer a great opportunity for both the company and sales channel to accelerate revenue. A sales initiative is simply a program launched through the enterprises' sales channels with the intention of increasing revenue. Examples of sales initiatives include, but are not limited to, new product launches, sales promotions, sales campaigns, new territories and new channels.

Whereever the term “configured to” is used herein, it is meant that the initiative designer, the system, the method and the computer-readable product according to the present disclosure are engineered or structured such that computer-readable instructions can be implemented to carry out specific tasks or display features as described. This term is not to be confused with the configuration systems or configuration computer programs otherwise known in the art pertaining to customizing manufactured products.

The term “Data Federation,” “Federation of Data” and “federated database” are used interchangeably herein.

With the initiative designer, there are basically three steps (not to be confused with the seven detailed steps shown in the figures and further described herein) for creating an effective growth initiative: 1) scope; 2) build; and 3) approve and publish.

In the first basic step, the growth initiative creator (the author or designer of one or more specific growth initiative) is guided through an “interview process” to define the basic parameters of the growth initiative by inputting information and/or answering the following questions:

1) what type of growth initiative is being created;

2) what customers are targeted;

3) what sales channels and territories are included (or not included);

4) what product(s) and service(s) are involved;

5) who will be involved in building and approving the growth initiative; and

6) what are the target dates and budget for the growth initiative.

Other questions and other inputting of information can be used to guide the growth initiative creator. Using the information gathered in this “interview process” in conjunction with one or more of the appropriate growth initiative templates, the growth initiative creator initiates and coordinates execution of a project that builds out of the growth initiative.

In the second basic step, the initiative designer can coordinate the tasks and workflow of the design team in completing the build-out of the growth initiative. Tasks to be completed can include, but are not limited to:

1) detailed specification of customer attributes, territories, products, budgets and dates;

2) creation or selection of marketing content to support the initiatives, such as, but not limited to, channel and customer announcements letters, initiative collateral, and call guides;

3) identification and setup of the appropriate sales tools that will be used in execution of the growth initiative; and

4) input and setup of supporting activities for the growth initiative, such as, but not limited to, practice, coaching, a resource center and collaboration capabilities.

There can be one or more primary outputs from the initiative designer, such as, but not limited to, a growth initiative game plan file that can be used in conjunction with other components, systems or modules, to optimally launch and execute the growth initiatives through channels.

These components, systems or modules can include the OPPORTUNITY ANALYZER™, the INITIATIVE ANALYZER™, and the GAME PLAN™ (which is an interactive smart game plan), available from SUPERIOR EDGE® (these products are available via SUPERIOR EDGE®'s SALESEDGE ACCELERATOR™ Suite of products), as further described herein and in the disclosure of U.S. patent application titled “Interactive Smart Game Plan,” having Attorney Docket No. P68369). The capabilities and benefits of these modules, can include, but are not limited to:

1) providing the ability to identify and prioritize the good, better, and best prospects for a given growth initiative (OPPORTUNITY ANALYZER™);

2) providing the ability to identify the most lucrative and likelihood of closing sales opportunities based on current sales promotions and other initiatives (INITIATIVE ANALYZER™); and

3) providing the ability to launch and execute growth initiatives through sales channels (GAME PLAN™).

When the growth initiative building step is completed, the growth initiative is ready for final review and approval by the growth initiative creator and other approvers. Once it is approved, the growth initiative is ready for publishing, either manually via the launch plan document as previously described, or through the full SUPERIOR EDGE®'s SALESEDGE ACCELERATOR™ Suite of products.

The initiative designer according to the present disclosure can include built-in analytics capabilities that can provide leading indicators and can be generated from usage and activity rather than forms based reporting.

The interactive smart game plan that resulted from the initiative designer according to the present disclosure provides the ability for enterprises to effectively execute sales initiatives through their sales channels. Many of the attributes of the interactive game plan that are described herein are applicable to the initiative designer since it is the initiative designer that is a starting point for the interactive smart game plan. The description and characteristics of the game plan is important in that many of the game plan's features are determined by the rules and requirements of the initiative designer. Therefore, this disclosure describes features of both the interactive smart game plan and the initiative designer so that the breadth of the inventive concepts according to this disclosure can be fully appreciated.

The interactive smart game plan can vary in scope depending on the type of the growth initiative. For example, a product announcement can use a more extensive interactive smart game plan than merely a simple sales promotion. A key element of the interactive smart game plan is its process organization and action-orientation.

According to one or more embodiments of the disclosure, tools, resources and/or other aids can be displayed or sent to the salespersons at the appropriate time in the process. This approach has two effects: first the salespersons are guided through a process based on proven practices to maximize results, and second, the right tools and resources can be sent or displayed to the salespersons at the appropriate time. This prevents the salesperson from being required to search for information and tools during the sales process. The salesperson's electronic mail and/or calendar system that are connected to the smart interactive game plan can display or send the tools and content that are specific to each customer/prospect for each growth initiative. Thus, the interactive electronic mail and calendar within the smart interactive game plan is dynamically generated. This capability improves the execution of the growth initiative by the salesperson.

Details about the interactive smart game plan are described in U.S. patent application titled “Interactive Smart Game Plan,” filed concurrently herewith, having Attorney Docket No. P68369.

An optimal input component or initiative designer that can be utilized can have the following functions and components. The initiative designer can have at least one of, a product selection functionality, a segmentation functionality, an incentive functionality, a game plan functionality, and an analytics functionality. The initiative designer can utilize one or more database. Preferably, the database is a relational database. Such relational databases that can be utilized or implemented are available or supplied by companies such as MICROSOFT®, ORACLE®, TERRADATA™, etc. An example of a product from MICROSOFT® that can be utilized is MICROSOFT®'s MYSQL® technology. It is to be understood that the initiative designer and the opportunity analyzer are optional components and are not required for the interactive smart game plan. An input component such as the initiative designer is utilized as a starting point for the interactive smart game plan. Certain information and requirements of the growth initiatives are inputted via the use of this particular input component or initiative designer. Other input components can be used to input other information and requirements for the game plan and are not to be confused with this input component and initiative designer.

The initiative designer can be implemented to operate on the web, or any other mode of communication known in the art, and can be implemented as a software-as-a-service or in an enterprise-level suite of application. Thus, the initiative designer can be configured to operate as a stand-alone computer product (i.e., on a computer-readable medium) on a world-wide web, on a wide area network, or on a local area network.

The dispersal of information from one or more databases can also be accomplished by utilizing or implementing the already available services of “Data Federation” vendors. Such databases or data providing companies, or “Data Federation” vendors that can be utilized according to the present disclosure, include, but are not limited to those available from IBM®, METAMATRIX®, SYPHERLINK™, INFORMATICA®, TRILLIUM®, JASPERSOFT®, COGNOS®, and SAS™.

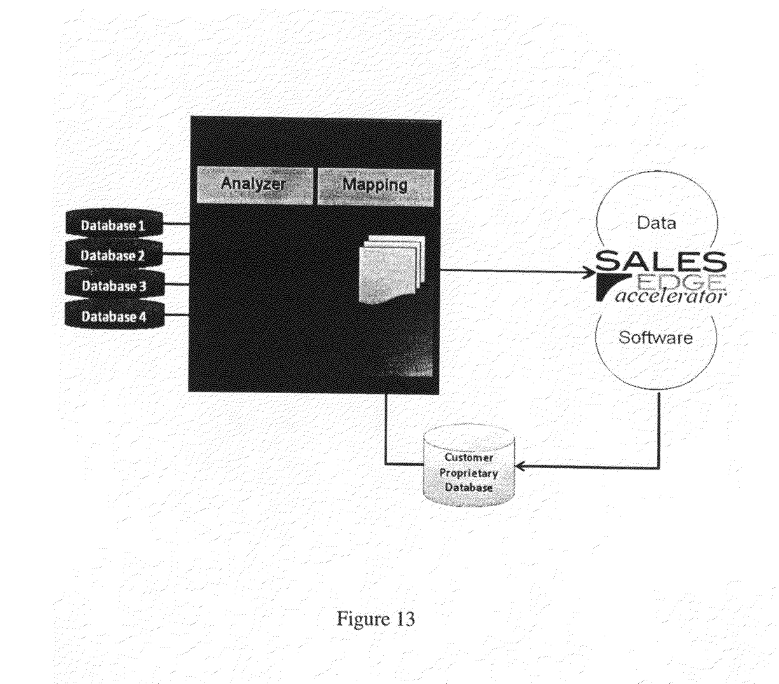

Data Federation is the ability to query and use multiple data sources without having to move or reconcile the data elements into a single data source. Data Federation is achieved by creating a virtual or logical data model and mapping the elements of the data model to physical data sources. FIG. 13 shows how the Data Federation of databases can be utilized in the initiative designer.

For example, more than one databases (i.e., Database 1 . . . Database 4) represent independent physical data sources. These data sources can be of many forms (RDB, flat file, XML, spreadsheet, legacy files, etc.). The data sources are mapped via a virtual or logical data model (which can reside within SUPERIOR EDGE®'s SALESEDGE ACCELERATOR® product), which in turn, the SALESEDGE ACCELERATOR®'s initiative design module will utilize as part of the process to create a growth initiative.

Within the initiative designer, the virtual or logical data model is utilized when the growth initiative creator is defining the segmentation (or targeted prospects) for the growth initiative. The growth initiative creator accesses the virtual or logical data model via the graphical user interface. Each growth initiative creator is assigned access rights as part of the user setup process. These access rights determine which tables and which fields the growth initiative creator can access when defining the segmentation criteria. In its most simplistic form, the segmentation criteria are simple queries into the virtual or logical data model.

The integration of the Data Federation of databases along with initiative designer is illustrated in the examples shown in the figures that are further described below.

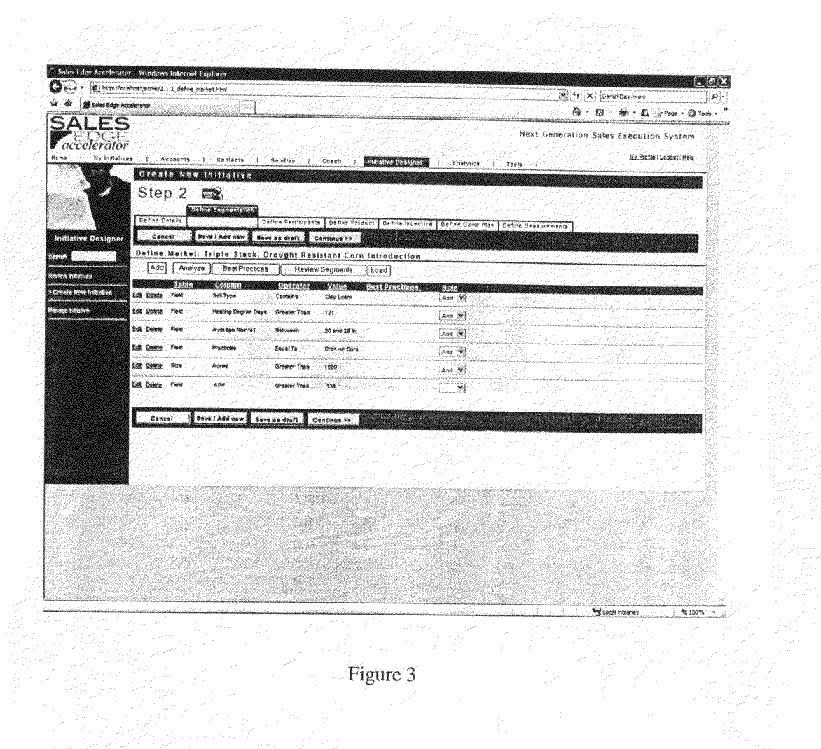

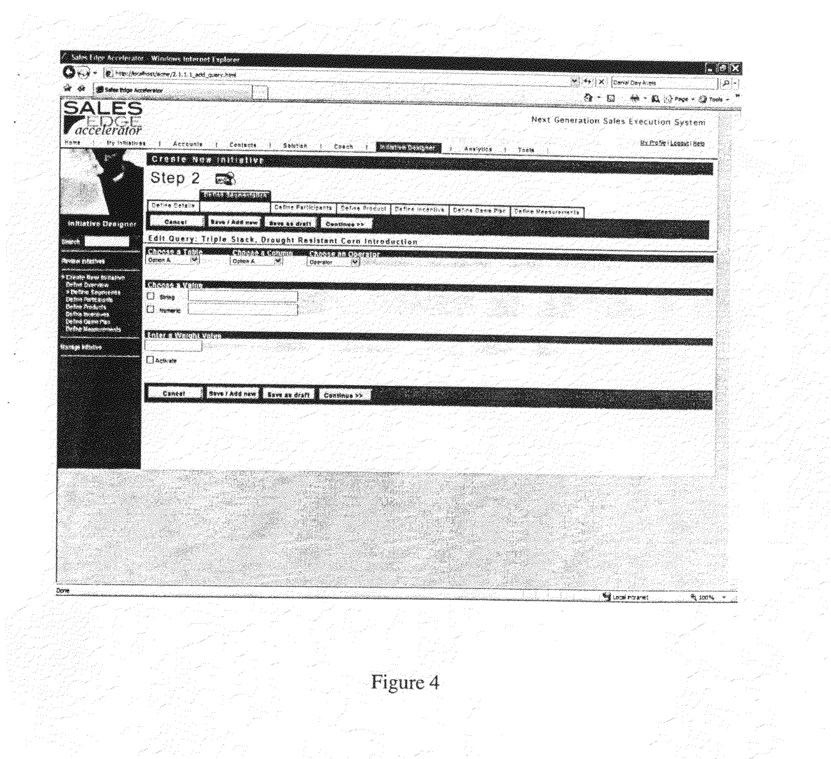

For example, when the growth initiative creator is defining the criteria to use to identify the prospects (target market) for the growth initiative, the growth initiative creator will select the “add” button shown in FIG. 3. This will take the growth initiative creator to the screen shown in FIG. 4. The growth initiative creator then selects “choose a table” from a selection list. This selection then accesses the virtual or logical data model and the identified tables. To the growth initiative creator, these tables will appear as a part of a single database. By selecting a table from the list, the data federation technology is actually selecting a physical table potentially from an external data source provided by SUPERIOR EDGE®, or a proprietary data source that was provided by the growth initiative creator (customer). For example, the growth initiative creator may select “customer table” from the selection list. The “customer table” is a virtual data table and is mapped via the federation technology to an external data source (i.e. Database 1). Conversely, the growth initiative creator could select “products table” from the selection list. The “products table” is a virtual data table and is mapped via the federation technology to an external data source (i.e. Database 2). Finally, the growth initiative creator could select “purchase history table” from the selection list. The “purchase history” selection list is a virtual data table and is mapped via the federation technology to the customer proprietary database that contains transactional purchasing history of the company's customers.

Once the growth initiative creator has selected a table, the data federation technology analyzes the physical table to understand what data columns exist in the table. If the column in the physical table is labeled with a cryptic name, the cryptic name is translated to a user-friendly name via metadata information (Metadata is structured information that describes, explains, locates, or otherwise makes it easier to retrieve, use, or manage an information resource. Metadata is often called data about data or information about information).

After the growth initiative creator has selected the desired table from the drop down list, the “choose a Column” selection list is automatically populated with the columns from the physical table in the database. Thus the growth initiative creator then selects which column in the table he or she would like to use as part of the query.

The growth initiative creator then selects the appropriate operator for the query from the “Choose an Operator” selection list. The operator can be a Boolean type (i.e. less than, greater than, equal to, contains, etc.).

Finally, the growth initiative creator inputs the appropriate value (String based, or Numeric), and assigns a weight of importance and selects whether the criteria is included in the analysis by selection of the active check box.

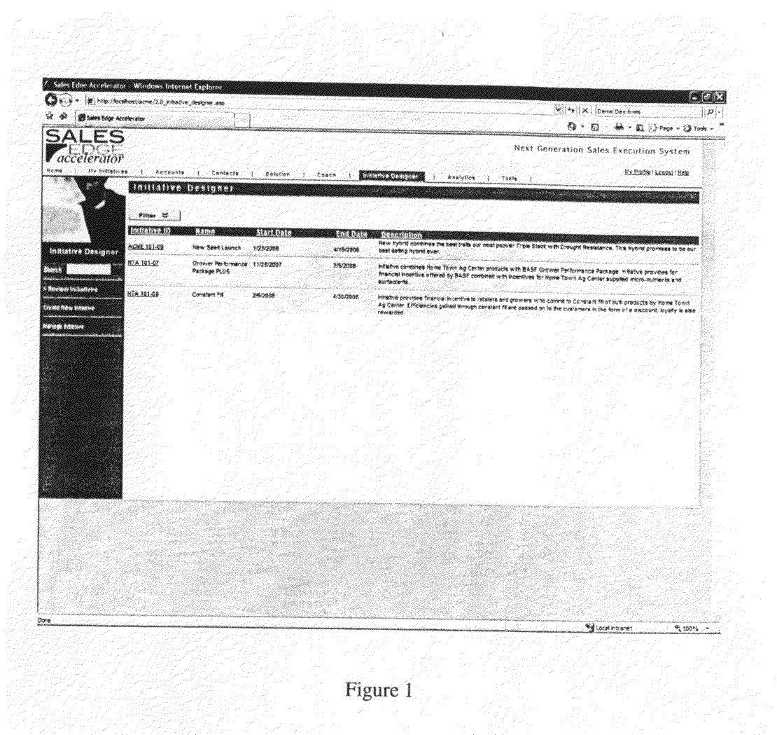

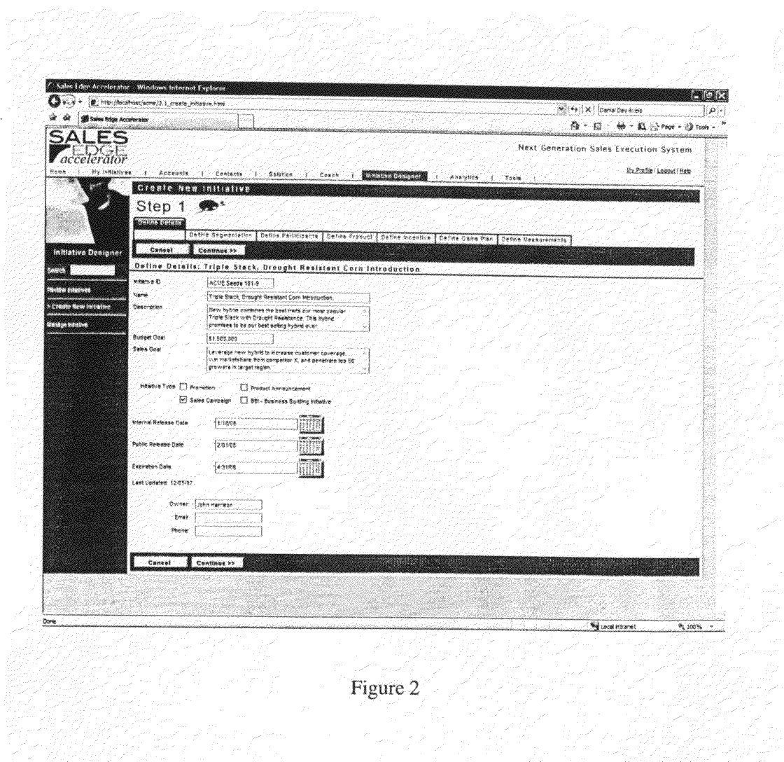

FIG. 1 shows a screen of the initiative designer according to the present disclosure. This screen is accessible to the growth initiative creator and is the starting page for the initiative designer. Here, the growth initiative creator can view basic information about existing growth initiatives (initiative ID, name, start date, end date and description). General buttons and menus on this screen can be utilized for other screens which are apparent and also shown in the screens shown in FIGS. 2-12 for example. These buttons, menus and lay out format can assist the growth initiative creator to go from one screen to another, view certain information with ease, allows quick retrieval of information, or enter and exit the system with security.

For example, a “Logout” button can allow the growth initiative creator to log out of the system and a “Help” button can allow the designer to pull up additional information that may be deemed as helpful for the growth initiative creator to create the growth initiative.

A menu can be placed on the left of the screen as shown, to identify the screen, along with one or more sub-menus. In FIG. 1, both the top and side of the menu shows “Initiative Designer” in order to identify the specific screen. A sub-menu is shown wherein three options are allotted to take the user to additional screens, such as “Review Initiative,” “Create New Initiative,” and “Manage Initiative.”

A “Search” box and a “Go” button allow the user to enter certain text in order to find specific information with ease. Beneath this section, a “Home” button takes the user to the home screen.

At the top of the screen of FIG. 1, “Filter” is indicated that allows the user to see a glimpse of one or more growth initiatives. If the growth initiative creator hits the “Filter” button, he or she can filter the information as desired. For example, this button can take the growth initiative creator to another screen (not shown). For example, the other screen can have a “Show All” option, which if selected, will display brief information about all of the available growth initiatives. However, the growth initiative creator can look for a specific growth initiative by entering the required information in one of the boxes: Initiative ID, Initiative, Publish Date and Expire Date. A “Filter Name” box can allow the growth initiative creator to go to a particular filter screen that was previously set up by the growth initiative creator and that was saved by using a “Save Filter” button (all not shown in FIG. 1).

In FIG. 1, basic information for three growth initiatives is shown in this example. The basic information can include, but is not limited to, an initiative ID (an identification code set up by the growth initiative creator to identify a specific growth initiative), a name of the product or service, a “start date” for the growth initiative, an “end date” for the growth initiative and a brief description of the growth initiative. A filter button allows filtering of certain information. Other buttons and displays of information are possible.

FIG. 2 shows a starting screen for “Create New Initiative” when this button is selected from the left menu of the screen of FIG. 1. As shown in this figure, there are seven tabs or seven steps in creating a growth initiative. Thus, FIG. 2 shows step 1 which is “Define Details” for the growth initiative. Here, the growth initiative creator can create a growth initiative by entering information about a growth initiative and requirement for a game plan. After a growth initiative is defined the growth initiative creator can then define the segment(s), assign the participant(s), assign the product(s), define the incentive(s), define the game plan, define the measurements and publish the growth initiative. Information about the growth initiative can include, but is not limited to, growth initiative ID, name, brief description, budget goal and sales goal. The type of growth initiative can be identified. In the example shown in FIG. 2, four basic types of growth initiative can be selected to describe the growth initiative: promotion, sales campaign, product announcement and business building growth initiative. Other choices are possible.

In the middle of FIG. 2, multiple date input boxes and basic calendar controls are shown. This information allows the growth initiative creator to select an internal release date, a public release date and an expiration date. At the bottom of the screen, an “Owner” of the growth initiative can be identified, along with his or her e-mail address and phone number. Other information can be added to this screen.

FIG. 3 shows a screen for defining segments or target markets of the growth initiative when the tab is selected (as shown on the top, “Define Segmentation” (Step 2)). Thus, this screen shows a summary of the criteria that will be used to determine the segmentation or targeted prospects. In the particular example shown in FIG. 3, segments of a Triple Stack, Drought Resistant Corn Introduction growth initiative are being defined. The growth initiative creator can input, modify, study and save information by hitting one of the buttons shown.

The example of FIG. 3 shows six categories of information or requirements of a particular segment of a particular growth initiative. An edit button and a delete button allow the growth initiative creator to edit and delete specific information or requirements. Here, the growth initiative creator can provide user requirements for a segment as shown, and with the help of the rule button shown on the right side of the screen. In this particular example, the “and” rule is selected which indicates that all six categories are required for this particular segment. The growth initiative creator can require other rules such as, but is not limited to, or, but, except, etc. (i.e., Boolean logic). Thus, an example of one of the requirements for the segment shown in FIG. 3, is that the size in acre must be greater than 1000 along with the five other requirements for this particular segment.

As indicated previously, other buttons and layouts for the screens are possible to assist a user to design a growth initiative. Possible additions are shown in FIG. 3. However, specific for FIG. 3, additional buttons are shown: Cancel, Save/Add New, Save as Draft, Continue, Add, Analyze, Best Practice, Review Segments and Load. Other buttons are possible.

When the growth initiative creator hits the “Save/Add New” button shown in FIG. 3, the growth initiative creator is taken to the screen shown in FIG. 4. Here, additional requirements, rules and modifications can be entered by the growth initiative creator.

This figure illustrates how the growth initiative creator can add additional parameters (or query) to the criteria with respect to defining the segmentation as described above for FIG. 3. The growth initiative creator first selects which table in the virtual or logical data model to access (i.e., Account Table, or Crops Planted, or Equipment, etc.). By choosing a table, the initiative designer segmentation functionality then populates the “Choose a Column” drop down list with the attributes of the table (in databases these attributes are normally referred to as columns of the table).

The growth initiative creator then selects which Column (or Attribute) to use (i.e., within the Account Table, the growth initiative creator may select the State attribute, or Zip Code Attribute, or Area Code Attribute).

Next the growth initiative creator selects the type of operator to use in the segmentation query. In this example, if the growth initiative creator selected Zip Code when choosing a Column in the Account Table, the user may select “Equal To” as the operator for the segmentation query. By choosing “Equal To”, the growth initiative creator is instructing to the initiative designer segmentation function that it is to look for Accounts with Zip Codes that match whatever is indicated in the “value” input area. Other examples of operators are Greater Than, Less Than, Contains, etc.

Next, the growth initiative creator inputs a “value” into the parameter or query. This value can be of String character (which indicates the value can be of alpha numeric characters) or Numeric character (which indicates the value will be a number).

Finally, the growth initiative creator has the ability to weight the parameter (or query) which will indicate how important this parameter or query is relative to any other parameter or query that is currently included in the criteria.

The activate checkbox allows the growth initiative creator to turn on/off a parameter (or query) that is part of the criteria to determine its effects on the limitation of the prospects (i.e., if the growth initiative creator creates a parameter or query that restricts the number of prospects that match the criteria, the growth initiative creator may deem the amount of opportunity or prospects to be too small to have an effective growth initiative).

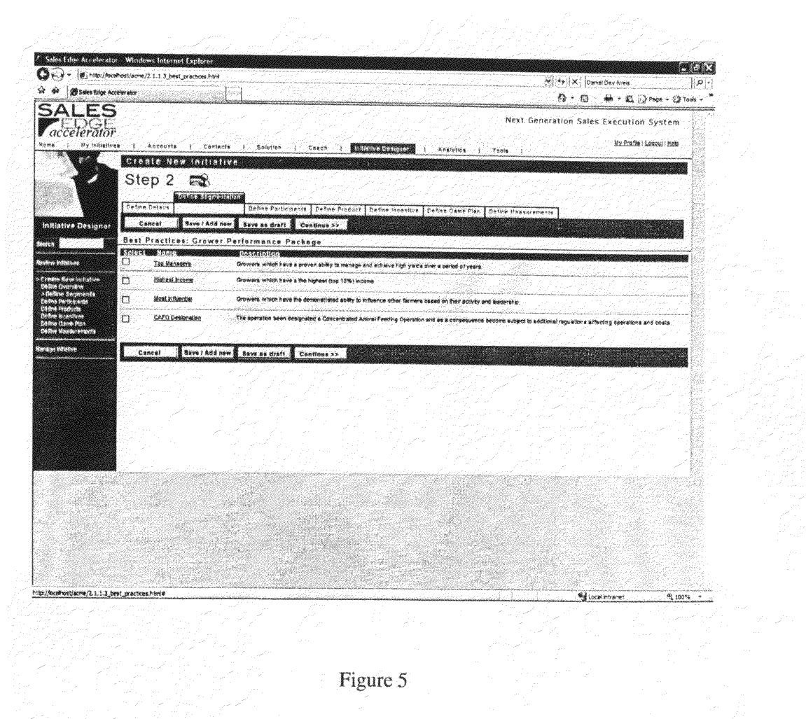

When the growth initiative creator hits the “Best Practice” button at the top of the screen of FIG. 3, the growth initiative creator is taken to the screen shown in FIG. 5. In the example for the screen shown in FIG. 5, there are four best practices: the top managers, highest income, most influential and CAFO Designation. A description or requirement for each best practice is shown. Other best practices are possible.

Once the growth initiative creator has completed defining the criteria for the segmentation, the growth initiative creator can “analyze” the results of the criteria against the federated database to determine how many prospects will be targeted in the growth initiative.

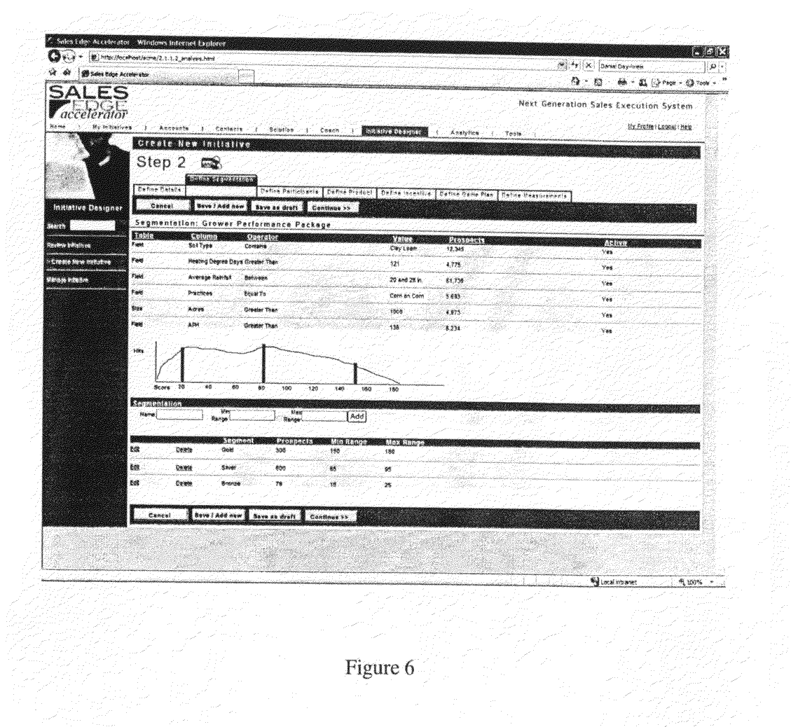

FIG. 6 shows a display screen upon selecting the “Analyze” button from FIG. 3. This screen shows the results of running the criteria (as defined in FIG. 3) against the federated data. The top part of the screen shows the criteria that were run against the federated data. Each individual query is listed and the results (i.e. “Hits” or “matches”) of each query are listed under the “prospect” column. For example, the first criteria of “Soil Type” contains “Clay Loam” and produced 12,345 prospects. This means that if the growth initiative creator used only the above mentioned criteria as the only query to search the data, there would be 12,345 prospects that match the above mentioned criteria.

The middle graph is the analysis of all the criteria and the associated weighting. In other words, it shows the intersection of all the criteria listed above. The reason why it shows a “score” on the X axis is due to the fact that when the criteria was defined, the growth initiative creator had the ability to apply a weighting to each of the criteria which identified the importance of each criteria relative to the other criteria.

The red lines in the graph indicate how the growth initiative creator wanted to segment the results (these segment definitions are listed in the table below the graph). In this example, there are 3 segments: Gold, Silver and Bronze. The Gold segment is any prospect that scored between 150 and 180 and there were 300 prospects that scored between 150 and 180. Similar information for the Silver and Bronze are also listed. Between the graph and the table is where the growth initiative creator can create additional segmentations by completing the 3 input boxes and selecting the add button. Thus, this figure illustrates the results of the criteria when executed against the virtual or logical database as described above. Other detail information that may be shown is possible.

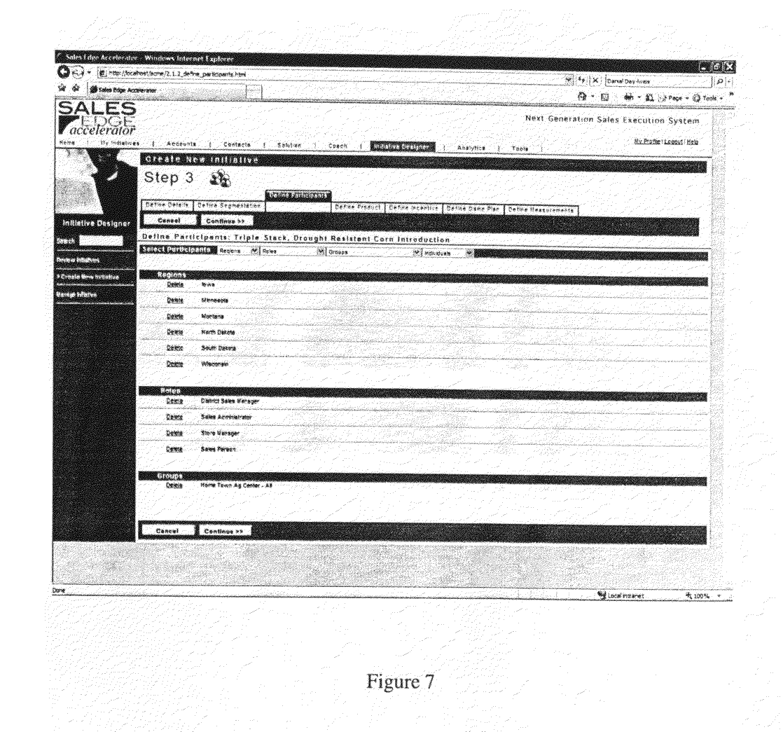

FIG. 7 shows the “Define Participants” (step 3) screen when this tab is selected. The growth initiative creator can define the participants or select the participants for the growth initiative. Selection can be based on regions, particular roles, particular groups and particular individuals. The growth initiative creator can vary the requirements as deemed necessary. In this example, there are six states defined for the regions for the participants, four types of roles (i.e., district sales manager, sales administrator, store manager and sales person), and one group. However, other regions, roles and groups are possible. Once any of these fields are entered by the growth initiative creator, he or she can easily delete certain information or requirements, if desired, by the use of the delete button next to each item.

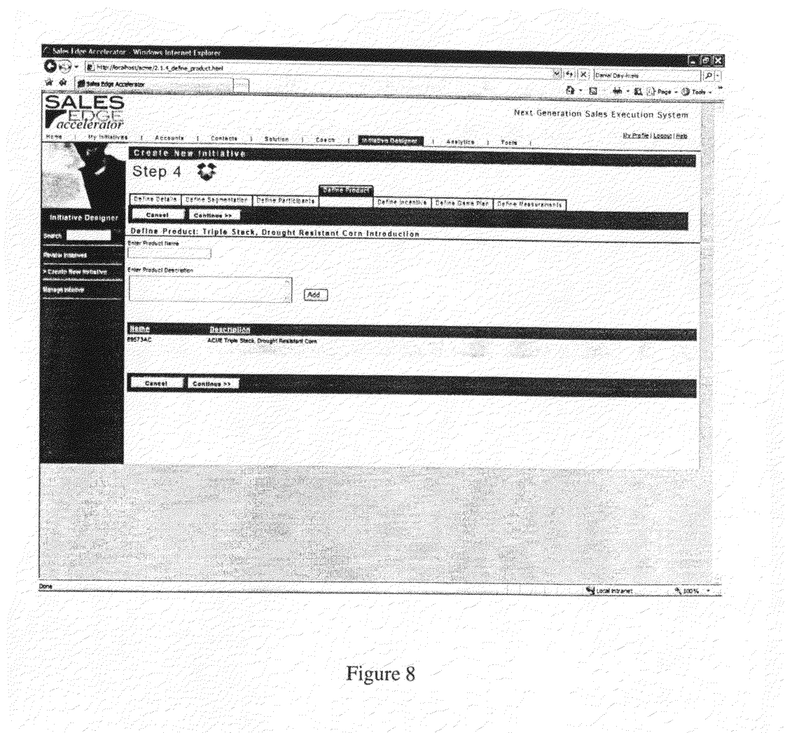

The growth initiative creator can define the products (step 4) for the growth initiative as shown in FIG. 8. In doing this, the growth initiative creator can determine the best product for the growth initiative. The growth initiative creator can enter the name of the product and a description of the product. An add button allows the designer to add this information which is then listed in the middle of the screen as shown. A button can allow the growth initiative creator to allow a distributor to bundle two or more products (not shown). Other ways of defining a product are possible based on the growth initiative creator's preference.

During this stage of designing the growth initiative, software products can be utilized in handling business rules for configuring the products that are described in FIG. 8 above. An example of such software products is a product configurator CPQ®, from WEBCOM® Inc. This software works behind the scene in populating information relative to the products that are relevant for the growth initiative. Including CPQ® from WEBCOM®, these types of configuration products are available from FIREPOND®, BIG MACHINES™, and others. The CPQ® configurator from WEBCOM® is a product known as a configuration engine. A configuration engine enforces business rules on how a product can be sold, manufactured, priced, etc.

An example of business rules for a product is a 24 inch bicycle frame, having the ability to be sold with 20 inch wheels or 24 inch wheels, but not with 16 inch wheels. Another example is a 18 inch bicycle having the ability to be sold with 16 inch wheels or 20 inch wheels, but not 24 inch wheels. Thus the configuration product will enforce the business rules such that a user that selects a 24 inch bicycle cannot select the 16 inch wheels. If the user wants 16 inch wheels the user must select the 18 inch bicycle frame. Another example, is that the 20 inch wheels are priced at $10.00 when included on a 18 inch bicycle frame and $20.00 when included on a 24 inch bicycle frame. The configuration engine will enforce the correct price of the product based on the user selection of bicycle frame.

In order to create a workable growth initiative, the growth initiative creator needs to be able to select a product and all of its optional components (i.e., bicycle frame and wheels). Thus, configuration products such as CPQ® from WEBCOM®, will ensure that the user selects the product(s) and applicable option(s) correctly. Of course, other software products available on the market can be utilized or implemented for this task.

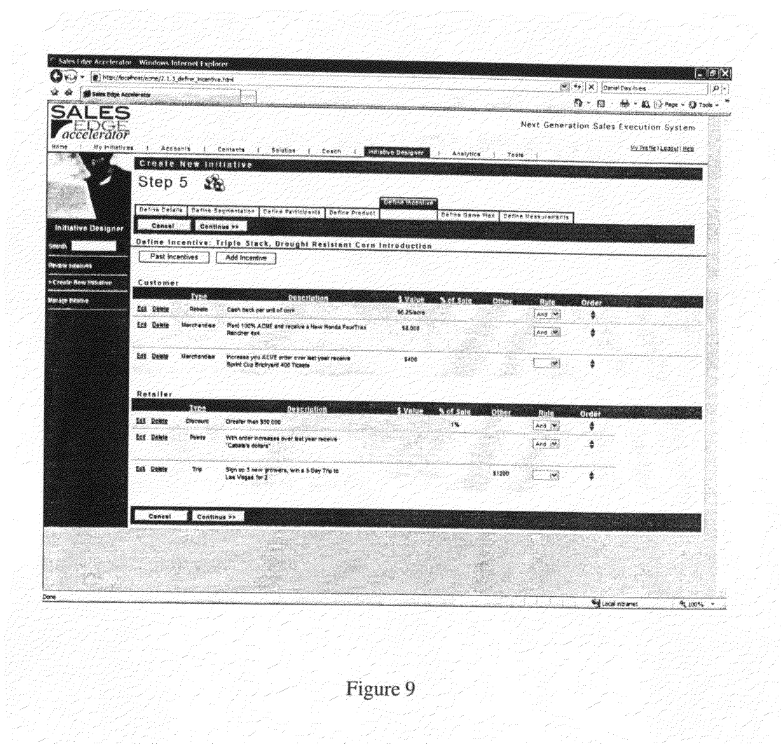

FIG. 9 shows a screen that allows the growth initiative creator to define incentives (step 5) for the growth initiative and/or game plan. Past incentives can be viewed by depressing the “Past Incentives” button. Additional incentives can be added by the use of an “Add Incentives” button as shown. Once relevant data has been added by the use of this button, the new incentives are populated in the screen. Similar incentives can be categorized and grouped together. In this example, there are two groups of incentives, based on a target group, such as a customer versus a retailer. Other groupings are possible.

The type of incentive can be listed (such as a rebate for the customer and a discount or a trip for the retailer), as well as the description of the incentive, the monetary value of the incentive, if known, and the percentage of the sales based on the incentive. Additional buttons that can be utilized in this screen include, but are not limited to, an edit button to edit an incentive, a delete button to delete an incentive, a rule operator selector to provide the rule or requirement of the incentive for the growth initiative (i.e., a rule such as “and” which requires or combine one incentive with another incentive, or an “or” rule which requires one incentive or another incentive for the growth initiative), and a button to determine the order of the incentive (hierarchy). Complex rules and requirements may be utilized by the growth initiative creator and other methods of defining the incentives are possible.

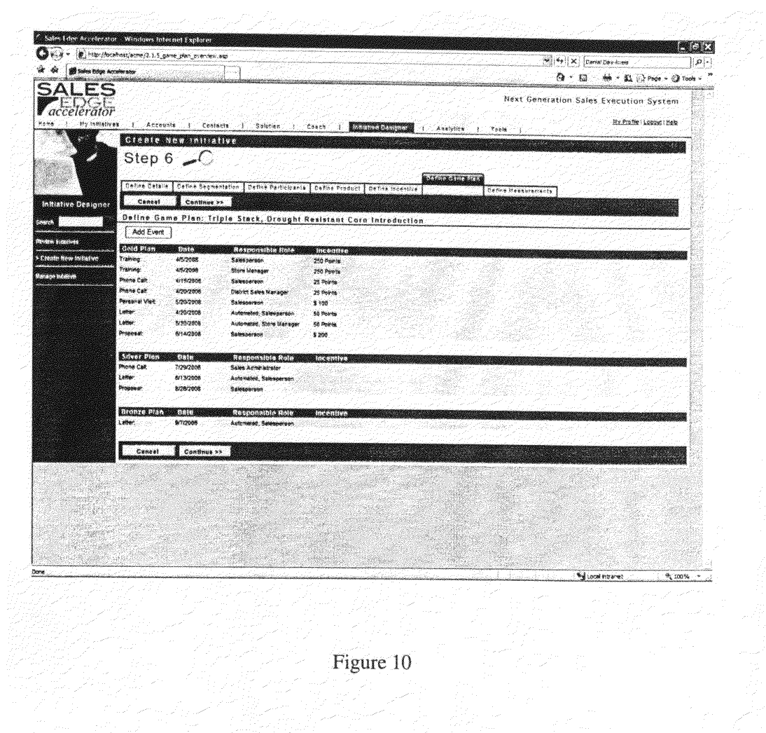

FIG. 10 shows a screen where the growth initiative creator can define a game plan for the growth initiative. For this example, three market segments for the game plan are established, which are listed as the Gold Plan for a first market segment, the Silver Plan for a second market segment and the Bronze Plan for the third market segment. In this screen, the person responsible is displayed under “Responsible Role” for each of the market segments. The Gold Plan is the suggested plan (activities) the salesperson should execute when working on prospects that most matched the desired attributes of the segmentation query (i.e., rated the highest in terms of matching the criteria). The Silver Plan is the suggested plan (activities) the salesperson should execute when working on prospects that fell into the second segmentation group from the segmentation query (i.e., rated within the second group in terms of matching the criteria). The Bronze Plan is the suggested plan (activities) the salesperson should execute when working on prospects that fell into the third segmentation group from the segmentation query (i.e., rated within the third group in terms of matching the criteria). In this example, for each of the market segments, a responsible person is already determined, along with an established training date, a phone call date, a personal visit date, a date for sending a letter, and a proposed finishing date for each of the responsible persons. Other features of a game plan can be implemented as described in the disclosure titled “Interactive Smart Game Plan,” having attorney docket number P68369.

In this example, requirements for the Gold Plan include the activities of training, phone calling, a personal visit, sending a letter and sending a proposal, while the Silver Plan requirements include the activities of phone calling, sending a letter, and sending a proposal, and the Bronze Plan requirements include only the activity of sending a letter. Other numbers and types of activities required for each plan are possible.

The responsible role can include, but is not limited to, a salesperson, a store manager, a district sales manager, and a sales administrator. The sending of the letter can be automated as indicated. The automation of this process is one advantage of the interactive smart game plan of the disclosure titled “Interactive Smart Game Plan,” having Attorney Docket No. P68369.

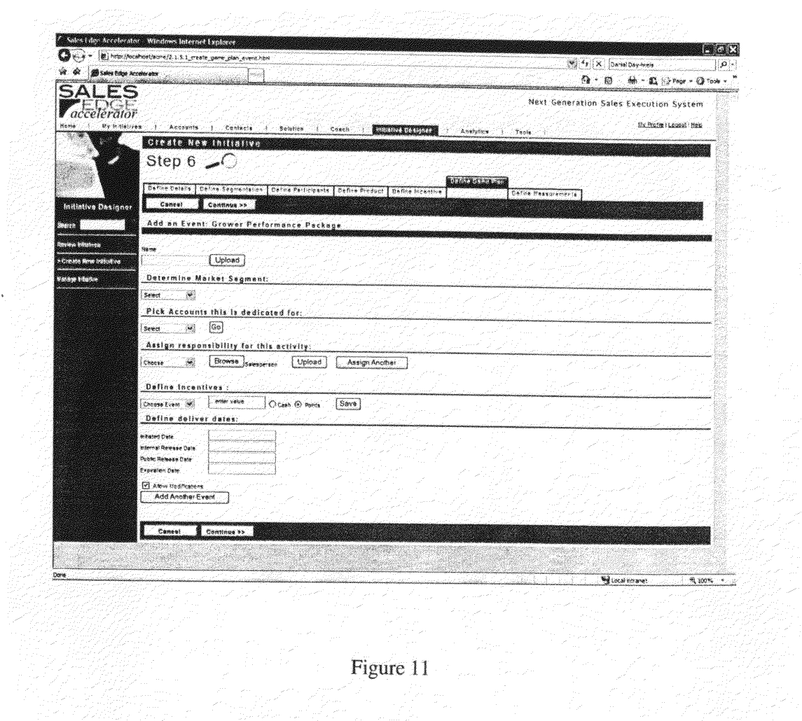

An “Add Event” button as shown, allows the growth initiative creator to add an event or activity that is deemed required for any one of the plans. When this button is selected, the growth initiative creator is taken to the screen shown in FIG. 11. As shown, the growth initiative creator can name the name of the event and can upload an event that is already established through the use of the “Upload” button next to this feature. The growth initiative creator then can select and determine the market segment (Gold, Silver or Bronze for example) for the event that is being added. Next, the growth initiative creator can pick the account or accounts this event can be dedicated for, i.e., for a particular growth initiative. The account can be selected from an already set list of accounts and the selection is executed via the use of the “Go” button next to this feature as shown.

After the account is selected, the user or designer can assign the responsibility of the activity to one or more individuals such as those shown in FIG. 11.

Next, the growth initiative creator can define the delivery dates for the event or activities. The delivery dates include, but are not limited to, an initiated date, an internal release date, a public release date and an expiration date. The initiated date is the date when the activity must or should be executed. The internal release date is the date that the growth initiative creator would like the activity to be viewable to only a selected group of people, which can be, but not necessarily, only those who are actively involved in a particular growth initiative or game plan. The public release date is the date that the growth initiative creator would like the activity to be viewable to a wider group of people than those for the internal release date. This group of people can be, for example, anyone who may be interested in participating in the growth initiative or game plan. The expiration date is a date that the growth initiative creator has determined that the activity can no longer be executed.

The “Allow Modifications” check box in FIG. 11 indicates whether or not the growth initiative creator will allow the salesperson to modify the game plan event once the growth initiative has been published. If the answer is yes, the salesperson will have the ability to decide if the he or she wants this particular step to be executed. However, once the growth initiative has been published to the salespeople, a particular salesperson may decide that some of the steps do not work in his or her particular situation, and thus, does not want them executed (i.e., if one of the steps is to call a prospect at a particular time and the salesperson does not want to execute the activity, the salesperson can turn off the activity and thus not executing the step).

An “Add Another Event” button shown at the bottom of FIG. 11 allows the growth initiative creator to add another event. When this button is selected, the information entered is automatically saved and implemented in the game plan and a new screen with blank fields is shown for the growth initiative creator to repeat the above-described process.

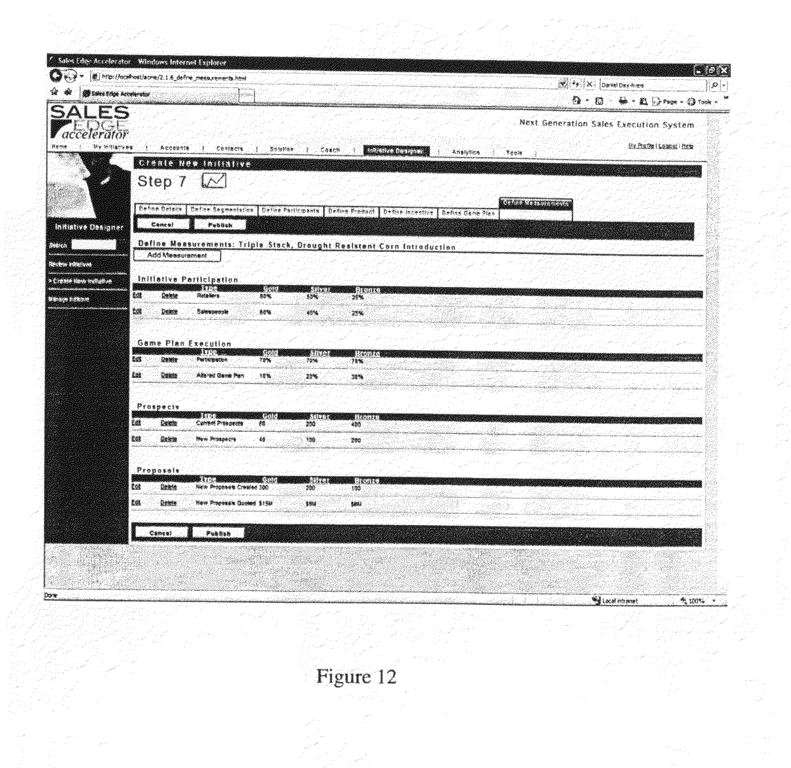

FIG. 12 shows a screen where the growth initiative creator can define measurements (step 7) when creating a new growth initiative. In this example, four ways of measuring the performance or requirements for each plan or segments are shown (growth initiative participation, game plan execution, prospects and proposals). Other ways and number of measurements are possible.

A “type” indicator can be utilized to show the type of each of the four measurements. An edit button and a delete button are utilized to edit and to delete the type of listed measurements.

For example, the growth initiative creator for this growth initiative has set the requirements that of retailers, 80% participation is required for the gold plan, 50% participation is required for the silver plan, and 25% participation is required for the bronze plan. Next, he or she has set the requirements that of salespeople, 60% participation is required for the gold plan, 40% participation is required for the silver plan, and 25% participation is required for the bronze plan. Of course, other types of participants for each plan and the percentages of participants for each plan are possible.

In this example, the second method of measurement is the game plan execution. The growth initiative creator for this growth initiative has set the requirement for participation to be 70% for the gold plan, 70% for the silver plan, and also 70% for the bronze plan. However, execution percentage for an altered game plan (an alternative game plan that the growth initiative creator has established), is 10% for the gold plan, 20% for the silver plan, and 30% for the bronze plan.

In the third method of measurement, the number of current prospects and the number of new prospects are determined. In the example shown, the number of propects required for the gold plan is higher than those of the other plans, but this allows a lower number of new prospects for the gold plan compared to the other plans.

In the fourth method of measurement, the number of new proposal created and the monetary amount for new proposals quoted, are shown for each of the plans.

As shown at the top of FIG. 11, the growth initiative creator can add other methods of measurements. At the bottom of the screen, the growth initiative creator can either cancel or publish the measurements via the use of the respective buttons. As described earlier, once something is “published,” a wider group of viewers as deemed by the growth initiative creator, can see the particular information.

Embodiments of the present disclosure may be applied in the context of a computer system. The system can include a conventional personal computer, including a processing unit, a system memory and a system bus that couples the system memory to the processing unit. System memory includes read only memory (ROM) and random access memory (RAM). A basic input/output system (BIOS) containing the basic routines that help to transfer information between elements within the personal computer, is stored in the ROM.

Embodiments of the present disclosure can be applied in the context of computer systems other than the personal computer. These computer systems can include handheld and/or wireless devices (such as, but not limited to, wireless PDA (personal digital assistant) cell phones, PALM PILOT® devices, other PDA devices, and the like), multiprocessor systems, various consumer electronic devices, mainframe computers, and the like. Those skilled in the art will also appreciate that embodiments can also be applied within computer systems wherein tasks are performed by remote processing devices that are linked through a communications network (e.g., communication utilizing Internet or web-based software systems). For example, program modules may be located in either local or remote memory storage devices or simultaneously in both local and remote memory storage devices. Similarly, any storage of data associated with embodiments of the present disclosure may be accomplished utilizing either local or remote storage devices, or simultaneously utilizing both local and remote storage devices.

The personal computer can further include a hard disc drive, a magnetic disc drive, and an optical disc drive. A magnetic disc drive can be utilized to read from or to write to a removable disc. An optical disc drive can be utilized for reading data from (or writing data to) an optical media, such as a CD-ROM disc. The hard disc drive, magnetic disc drive and optical disc drive can be connected to the system bus by a hard disc drive interface, a magnetic disc drive interface, and an optical disc drive interface, respectively. The drives and their associated computer-readable media can provide nonvolatile storage for the personal computer. Other types of media that are readable by a computer may also be used in the operation environment.

A number of program modules can be stored in the drives and the RAM, including an operating system, one or more application programs, other program modules and program data. In particular, one of the other program modules can be any of the components described above that demonstrates certain features and embodiments of the present disclosure.

Input devices can include a keyboard and a mouse (or other pointing devices) and can be operably connected to the system bus through a serial port interface that is coupled to system bus. Input devices could be connected utilizing other interfaces such as a universal serial bus (USB). A monitor can be connected to the system bus through a video adapter. Other peripheral output devices (e.g., speakers or printers) can also be included. Other configurations of the system than those described above are possible.

The systems and methods according to the present disclosure can be implemented such that it can be functional via a world-wide web, a local area network or a wide area network. Accordingly, a computer program product readable by a computer system having computer-executable instructions that when executed cause a processor of the computer system to generate one or more of the personal electronic mails in the execution of activities in an interactive smart game plan for one or more growth initiatives can be utilized for the systems and methods according to the present disclosure.

For example, the personal computer can operate in a network environment utilizing connections to one or more remote computers. The remote computer can be a server, a router, a peer device, or other common network nodes. The remote computer can include many or all of the features and elements described in relation to any personal computer. The network connections can include a local area network (LAN) and/or a wide area network (WAN). Such network environments are commonplace in the art.

For example, the personal computer can be connected to the LAN through a network interface. The personal computer can also be connected to the WAN and can include a modem for establishing communications over the WAN. The modem can be internal or external, and can be connected to the system bus via the serial port interface. However, any other methods of communications that are different from a modem and are available in the art can be used.

In a networked environment, program modules relating to one or more computer readable products containing one or more components of the initiative designer, or portions thereof, can be stored in a remote memory storage device. For example, application programs can be stored utilizing a memory storage device that carry instructions to execute according to the smart game plan or that demonstrates certain features and embodiments of the present disclosure. It will be appreciated that the network connections described above are exemplary and other methods for establishing a communications link between the computers, such as a wireless interface communications link, can be used.

Notwithstanding the broad applicability of the principles of the disclosure described above, it should be understood that the configuration of the exemplary embodiments as an application program that is stored on, and enables data to be stored on, a remote computer provides significant advantages although the systems, methods and computer readable products as described above, already provide significant advantages in assisting a salesperson to directly connect the growth initiative to the sales and the execution of the growth initiative.

Therefore, as can be seen in the above examples, the initiative designer according to the present disclosure provides many benefits over traditional tools used by other companies in designing, implementing and executing a growth initiative or game plan. These tools that have been developed by certain companies are considered primary lead tools. The primary lead tools do not provide the ability to use a federation of data sources (including both a local source to the user and an external source to the user) to define the target market(s). Additionally, these tools do not focus on the game plan or the sales execution side of the growth initiatives (such as what happens to the opportunities once they are identified). Usually, they only identify the opportunities and then pass them off to the responsible person for follow up. The initiative designer according to the present disclosure overcomes these deficiencies by providing features that are necessary in creating and designing an effective growth initiative and an effective game plan.

The initiative designer makes it easy for corporate, field, and channel personnel to design and build actionable sales initiatives that obtain results. Thus, the initiative designer according to the present disclosure can provide key benefits, including, but not limited to:
1) effective growth initiatives can be quickly defined, built, approved and executed;
2) the use of growth initiative templates can drive consistency and predictability, and can allow for continuous improvement; and
3) growth initiatives can be conceived and executed at any level of the organization, from the corporate level, the field level or the channel level.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present disclosure in more detail than is necessary for the fundamental understanding of the present disclosure, the description taken with the drawings making apparent to those skilled in the art how the several forms of the present disclosure may be embodied in practice.

It is noted that the foregoing examples have been provided merely for the purpose of explanation and are in no way to be construed as limiting of the present disclosure. While the present disclosure has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although the present disclosure has been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed:

1. A system comprising an initiative designer for one of, creating, launching or tracking one or more growth initiatives, said initiative designer comprising:
an electronic component configured to interact with one or more users by accepting and displaying growth initiative information specified by the user and obtained from multiple data sources, pertaining to the growth initiative,
wherein the growth initiative information comprises at least one of, basic growth initiative information, a target segment, a target participant, an incentive, a business rule, a marketing tool, sales execution instructions, detailed prospect information, prospect background information, and a recommended game plan to a user to execute the growth initiative.

2. The system of claim 1, wherein the multiple data sources comprise at least one of, one or more external databases and one or more local user databases.

3. The system of claim 2, wherein the at least one or more external databases and one or more local user databases are relational databases.

4. The system of claim 1, wherein the multiple data sources are logically federated together to appear as a single database to a user without the need of the user to collate information from the multiple data sources.

5. The system of claim 1, wherein the initiative designer is configured to display one or more previously defined growth initiatives to a user to improve the definition and execution of a new growth initiative.

6. The system of claim 1, wherein the initiative designer further comprises tools configured to assist the user in analyzing rules that were created during a target market definition which show the user how many prospects are identified.

7. The system of claim 1, wherein the basic growth initiative information comprises at least one of, a reference identification, a growth initiative name, a sales goal, a growth initiative budget, a growth initiative description, a growth initiative type and effective dates for the growth initiative.

8. The system of claim 1, wherein the initiative designer is configured to at least one of:
guide the user to define who within an organization should receive the growth initiative information;
guide the user to define the incentives that are being offered as part of the growth initiative;
guide the user to define at least one of, products and services that will be offered as part of the growth initiative;
guide the user to define an interactive game plan to be executed by one of, an individual or a sales team;
guide the user to define the metrics or measurements that are desired to be tracked during the execution of the growth initiative; and
allow the user to publish the growth initiative for others to view.

9. The system of claim 1, wherein the initiative designer is configured to allow the user to view results of past growth initiatives in order to see how well the past growth initiatives accomplished a desired goal.

10. The system of claim 1, wherein the initiative designer is configured to receive information from a user to display at least one of, tools, resources and activities for execution at an appropriate time.

11. The system of claim 1, wherein at least one of, tools, resources and activities for execution are selected by a user who creates the growth initiative and is/are displayed at an orderly time to guide a user to maximize results for a game plan.

12. The system of claim 1, wherein the initiative designer has at least one of, a product selection functionality, a segmentation functionality, an incentive functionality, a game plan functionality and an analytics functionality.

13. The system of claim 1, wherein the initiative designer is configured to operate at least one of, as a stand-alone computer product/on a computer-readable medium, on a world-wide web, on a wide area network, and on a local area network.

14. A method for designing one or more growth initiatives for a smart game plan by one or more users, comprising:
utilizing and interacting with an electronic component that accepts and displays growth initiative information specified by the user and obtained from multiple data sources, pertaining to the growth initiative,
wherein the growth initiative information comprises at least one of basic growth initiative information, a target segment, a target participant, an incentive, a business rule, a marketing tool, sales execution instructions, detailed prospect information, prospect background information, and a recommended game plan to a user to execute the growth initiative.

15. The method of claim 14, wherein the user utilizes multiple data sources comprising at least one of, one or more external databases and one or more local user databases.

16. The method of claim 15, wherein the at least one or more external databases and one or more local user databases are relational databases.

17. The method of claim 14, wherein the user utilizes multiple data sources that are logically federated together to appear as a single database to the user without the need of the user to collate information from the multiple data sources.

18. The method of claim 14, wherein the user utilizes the initiative designer to display one or more previously defined growth initiatives to improve the definition and execution of a new growth initiative.

19. The method of claim 14, wherein the user utilizes tools from the initiative designer to assist the user in analyzing rules that were created during a target market definition which show the user how many prospects are identified.

20. The method of claim 14, wherein the basic growth initiative information comprises at least one of, a reference identification, a growth initiative name, a sales goal, a growth initiative budget, a growth initiative description, a growth initiative type and effective dates for the growth initiative.

21. The method of claim 14, wherein the user utilizes the initiative designer to at least one of:
guide the user to define who within an organization should receive the growth initiative information;
guide the user to define the incentives that are being offered as part of the growth initiative;
guide the user to define at least one of, products and services that will be offered as part of the growth initiative;
guide the user to define an interactive game plan to be executed by at one of, an individual or a sales team;
guide the user to define the metrics or measurements that are desired to be tracked during the execution of the growth initiative; and
allow the user to publish the growth initiative for others to view.

22. The method of claim 14, wherein the user utilizes the initiative designer to allow the user to view results of past growth initiatives in order to see how well the past growth initiatives accomplished a desired goal.

23. The method of claim 14, wherein the user utilizes the initiative designer to display at least one of, tools, resources and activities for execution at an appropriate time.

24. The method of claim 14, wherein at least one of, the tools, resources and activities for execution, are selected by a user who creates the growth initiative and is/are displayed at an orderly time to guide another user to maximize results for a game plan.

25. The method of claim 14, wherein the initiative designer has at least one of, a product selection functionality, a segmentation functionality, an incentive functionality, a game plan functionality and an analytics functionality.

26. The method of claim 14, wherein the initiative designer is configured to operate at least one of, as a stand-alone computer product/on a computer-readable medium, on a world-wide web, on a wide area network, and on a local area network.

27. A computer program product readable by a computer system having computer-executable instructions that when executed cause a processor of the computer system to perform a method for generating one or more display screens for one or more users to input information for one or more growth initiatives, the method comprising:
utilizing and interacting with an electronic component that accepts and displays growth initiative information specified by the user and obtained from multiple data sources, pertaining to the growth initiative,
wherein the growth initiative information comprises at least one of, basic growth initiative information, a target segment, a target participant, an incentive, a business rule, a marketing tool, sales execution instructions, detailed prospect information, prospect background information, and a recommended game plan to a user to execute the growth initiative.

28. The computer program product of claim 27, wherein the user utilizes multiple data sources comprising at least one of, one or more external databases and one or more local user databases.

29. The computer program product of claim 28, wherein the at least one or more external databases and one or more local user databases are relational databases.

30. The computer program product of claim 27, wherein the user utilizes multiple data sources that are logically federated together to appear as a single database to the user without the need of the user to collate information from the multiple data sources.

31. The computer program product of claim 27, wherein the user utilizes the initiative designer to display one or more previously defined growth initiatives to improve the definition and execution of a new growth initiative.

32. The computer program product of claim 27, wherein the user utilizes tools from the initiative designer to assist the user in analyzing rules that were created during a target market definition which show the user how many prospects are identified.

33. The computer program product of claim 27, wherein the basic growth initiative information comprises at least one of, a reference identification, a growth initiative name, a sales goal, a growth initiative budget, a growth initiative description, a growth initiative type and effective dates for the growth initiative.

34. The computer program product of claim 27, wherein the user utilizes the initiative designer to at least one of:
guide the user to define who within an organization should receive the growth initiative information;
guide the user to define the incentives that are being offered as part of the growth initiative;
guide the user to define at least one of, products and services that will be offered as part of the growth initiative;
guide the user to define an interactive game plan to be executed by one of, an individual or a sales team;
guide the user to define the metrics or measurements that are desired to be tracked during the execution of the growth initiative; and
allow the user to publish the growth initiative for others to view.

35. The computer program product of claim 27, wherein the user utilizes the initiative designer to allow the user to view results of past initiatives in order to see how well the past growth initiatives accomplished a desired goal.

36. The computer program product of claim 27, wherein the user utilizes the initiative designer to display at least one of, tools, resources and activities for execution at an appropriate time.

37. The computer program product of claim 27, wherein at least one of, tools, resources and activities for execution are selected by a user who creates the growth initiative and is/are displayed at an orderly time to guide another user to maximize results for a game plan.

38. The computer program product of claim 27, wherein the initiative designer has at least one of, a product selection functionality, a segmentation functionality, an incentive functionality, a game plan functionality and an analytics functionality.

39. The computer program product of claim 27, wherein the initiative designer is configured to operate at least one of, as a stand-alone computer product/on a computer-readable medium, on a world-wide web, on a wide area network, and on a local area network.
